(19) United States
(12) Patent Application Publication
(10) Pub. No.: US 2024/0200870 A1
(43) Pub. Date: Jun. 20, 2024

(54) Microwave vacuum low-temperature drying machine and process

(71) Applicant: SHANGHAI AILU PACKAGING CO., LTD., Shanghai (CN)

(72) Inventor: Ankang CHEN, Shanghai (CN)

(73) Assignee: SHANGHAI AILU PACKAGING CO., LTD., Shanghai (CN)

(21) Appl. No.: 18/211,616

(22) Filed: Jun. 20, 2023

Related U.S. Application Data
(63) Continuation of application No. PCT/CN2022/141247, filed on Dec. 23, 2022.

(30) Foreign Application Priority Data
Dec. 19, 2022 (CN) 202211634406.6

(51) Int. Cl. F26B 3/347; F26B 5/12; F26B 15/18; F26B 25/22

(52) U.S. Cl. CPC F26B 3/347; F26B 5/12; F26B 15/18; F26B 25/225

(57) ABSTRACT

A microwave vacuum low-temperature drying machine includes a frame and a conveyor. One side of the interior of the frame is provided with a drying chamber, and the other side of the interior of the frame is provided with an equipment chamber. An inner wall of the drying chamber is provided with a drying system. The drying system includes a first drying assembly located at upper parts of inner walls at two sides of the drying chamber, second drying assemblies respectively located at middle and lower parts of the inner walls at the two sides of the drying chamber, and a third drying assembly located between the second drying assembly at the middle parts and the second drying assembly at the lower parts. The machine can handle a large and high stacked material, and achieve uniform inside and outside drying of the stacked material, with high drying efficiency.

### CROSS REFERENCE TO THE RELATED APPLICATIONS

This application is the continuation application of International Application No. PCT/CN2022/141247, filed on Dec. 23, 2022, which is based upon and claims priority to Chinese Patent Application No. 202211634406.6, filed on Dec. 19 2022, the entire contents of which are incorporated herein by reference.

### TECHNICAL FIELD

The present disclosure relates to the technical field of vacuum drying devices, and in particular to a microwave vacuum low-temperature drying machine and process.

### BACKGROUND

After packaging bags are processed, they are stacked on a pallet and transported to a drying area. At present, a large and high stack of packaging bags is usually manually split into single packaging bags or small stacks of packaging bags before the packaging bags are dried by a microwave drying machine or an electric drying machine. The splitting operation increases labor costs and reduces drying efficiency. However, it is not suitable to directly dry the stacked packaging bags due to their large amount and height. It is hard to achieve uniform inside and outside drying of the stacked packaging bags simply by increasing the time or energy of the existing drying machines without causing damage to the packaging bags. In other words, the drying of the internal packaging bags will be incomplete, and there will be residual moisture in the internal packaging bags. In view of this, there is a need for a microwave vacuum low-temperature drying machine.

### SUMMARY

In order to solve the problems existing in the prior art, an objective of the present disclosure is to provide a microwave vacuum low-temperature drying machine. The present disclosure can handle a large and high stacked material, and achieve uniform inside and outside drying efficacy of the stacked material, with high drying efficiency and desired effects.

The above technical objective of the present disclosure is achieved by the following technical solutions. A microwave vacuum low-temperature drying machine includes a frame and a conveyor, where one side of the interior of the frame is provided with a drying chamber, and the other side of the interior of the frame is provided with an equipment chamber; an inner wall of the drying chamber is provided with a vacuum pump suction port; the vacuum pump suction port is connected to the equipment chamber; the inner wall of the drying chamber is further provided with a drying system; the drying system includes a first drying assembly located at upper parts of inner walls at two sides of the drying chamber, second drying assemblies respectively located at middle and lower parts of the inner walls at the two sides of the drying chamber, and a third drying assembly located between the second drying assembly at the middle parts and the second drying assembly at the lower parts; each of the first drying assembly, the second drying assemblies and the third drying assembly includes a plurality of dryers; the dryer includes a microwave power supply for emitting a microwave and a radiation port; and each radiation port is provided with a magnetron.

In some embodiments, the drying chamber is provided with an automatic sensing door.

In some embodiments, the equipment chamber is divided into an upper layer, a middle layer and a lower layer; the upper layer and the middle layer of the equipment chamber are provided with a cooling circulation system and a vacuum pump; the vacuum pump is connected to the vacuum pump suction port; the lower layer of the equipment chamber is provided with a drainage system; the cooling circulation system and the drainage system are connected to the drying chamber; and the cooling circulation system is connected to the first drying assembly, the second drying assemblies and the third drying assembly, respectively.

In some embodiments, a distance between the dryers in the second drying assembly is greater than a distance between the dryers in the third drying assembly.

In some embodiments, a conveying device is provided in the drying chamber, and a pallet is provided on the conveying device.

In some embodiments, a top of the drying chamber is provided with a silencer.

In some embodiments, temperature sensors are provided on the top and the inner walls at the two sides of the drying chamber.

In some embodiments, a weighing system is provided in the frame.

A microwave vacuum low-temperature drying process uses the microwave vacuum low-temperature drying machine, and includes the following steps:
step 1: weighing a stacked material; and transporting, by the conveyor, the stacked material into the drying machine;
step 2: controlling the drying system in the drying machine to dry the stacked material; and
step 3: weighing, by the weighing system, the stacked material after drying; calculating a weight difference of the stacked material before and after drying; and determining whether the drying is qualified.

To sum up, the present disclosure has the following beneficial effects:

The present disclosure dries the upper, middle, and lower parts of the stacked material through the first drying assembly and the second drying assemblies. The present disclosure achieves overall drying of the stacked material without affecting the color and composition of the stacked material, and achieves high drying efficiency. The present disclosure utilizes the third drying assembly to deeply dry the middle part of the stacked material in a concentrated manner, such that the moisture in the middle part of the stacked material is affected by the microwave energy, achieving uniform inside and outside drying, and improving the drying effect.

### BRIEF DESCRIPTION OF THE DRAWINGS

FIG. 1 is a first overall structural diagram of a microwave vacuum low-temperature drying machine according to the present disclosure;

FIG. 2 is a second overall structural diagram of the microwave vacuum low-temperature drying machine according to the present disclosure;

FIG. 3 is an overall internal structural diagram of the microwave vacuum low-temperature drying machine according to the present disclosure;

FIG. 4 is a first internal structural diagram of a drying chamber according to the present disclosure;

FIG. 5 is a second internal structural diagram of the drying chamber according to the present disclosure;

FIG. 6 is an internal structural diagram of an equipment chamber according to the present disclosure;

FIG. 7 is a structural diagram of a magnetron according to the present disclosure;

FIG. 8 is a schematic diagram showing a working state of the microwave vacuum low-temperature drying machine according to the present disclosure; and

FIG. 9 is a structural diagram of a stacked material according to the present disclosure.

Reference Numerals: 1. frame; 2. automatic sensing door; 3. conveyor; 4. drying chamber; 41. vacuum pump suction port; 42. silencer; 43. temperature sensor; 5. equipment chamber; 51. cooling circulation system; 52. vacuum pump; 53. drainage system; 6. magnetron; 7. conveying device; 8. drying system; 81. first drying assembly; 82. second drying assembly; 83. third drying assembly; and 9. radiation port.

### DETAILED DESCRIPTION OF THE EMBODIMENTS

The technical solutions of the embodiments of the present disclosure are clearly and completely described below with reference to the drawings. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

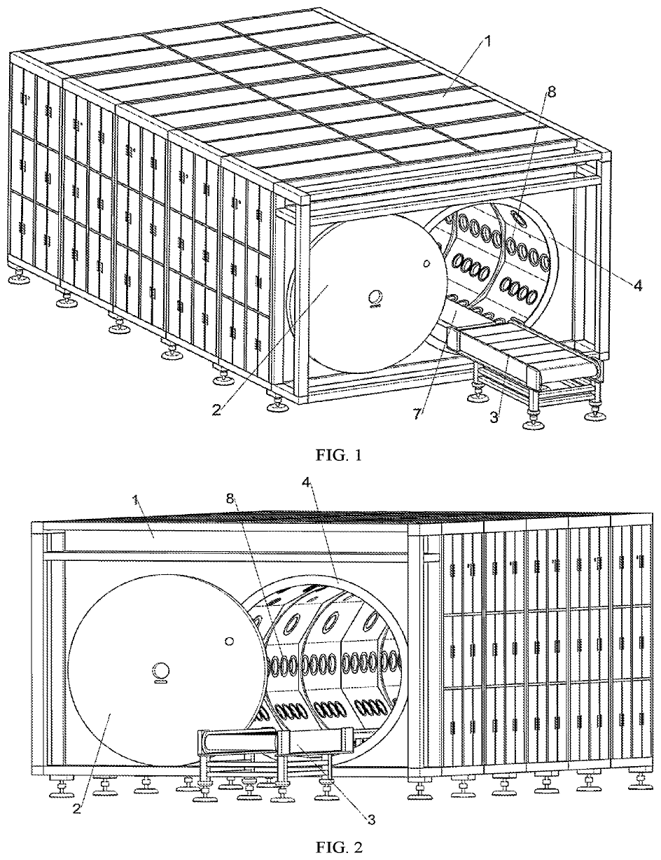

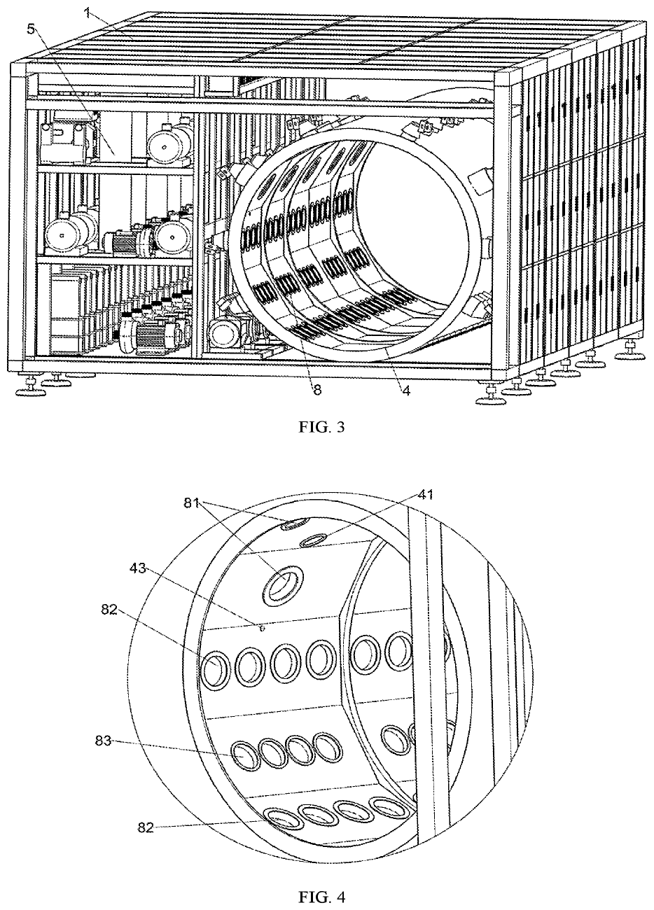

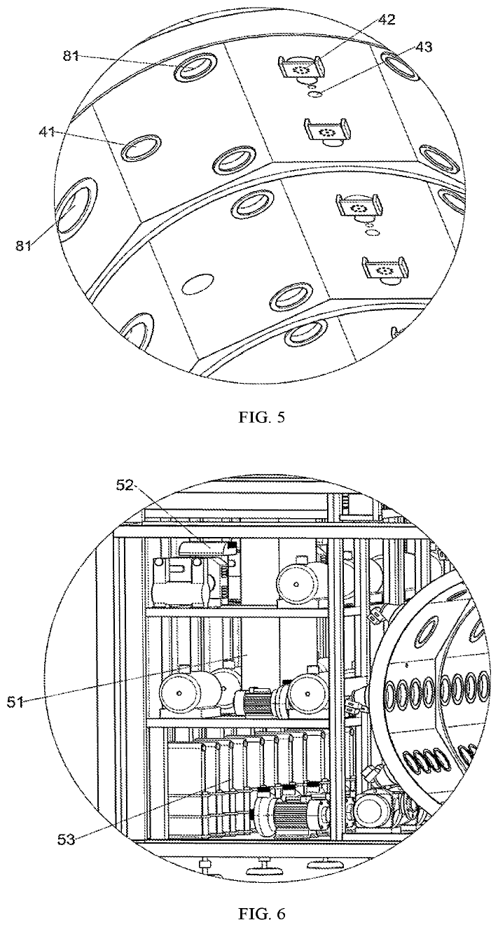

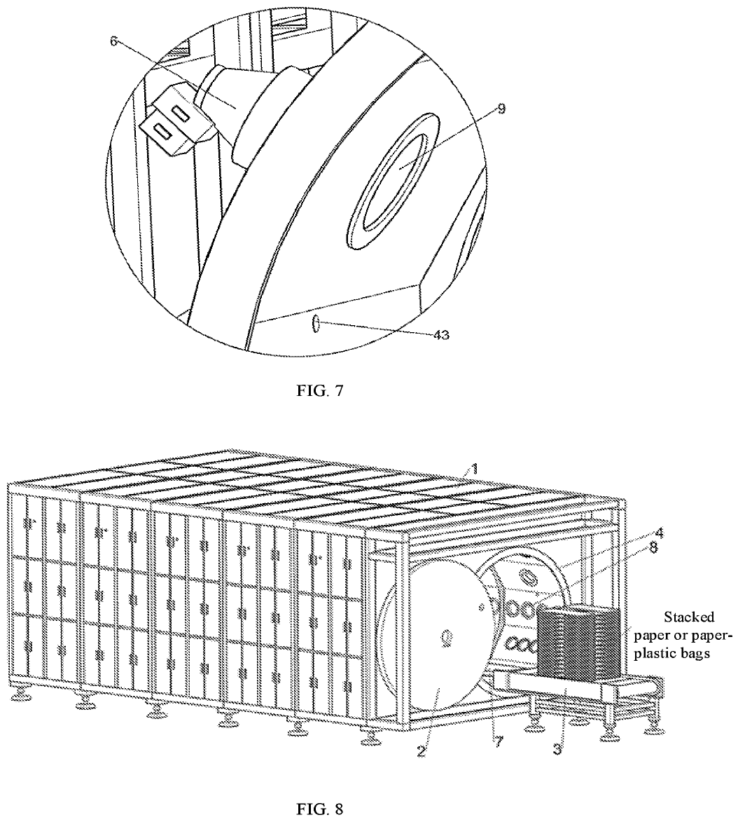

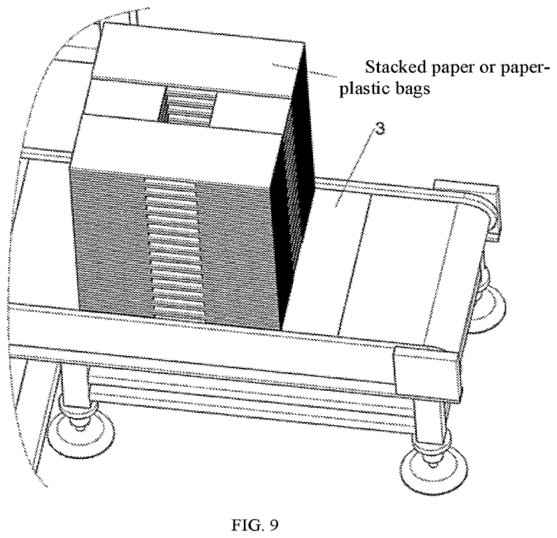

Refer to FIGS. 1 to 9, a microwave vacuum low-temperature drying machine includes frame 1 and conveyor 3. One side of the interior of the frame 1 is provided with drying chamber 4, and the other side of the interior of the frame 1 is provided with equipment chamber 5. An inner wall of the drying chamber 4 is provided with vacuum pump suction port 41. The vacuum pump suction port 41 is connected to the equipment chamber 5. The inner wall of the drying chamber 4 is further provided with drying system 8. The drying system 8 includes first drying assembly 81 located at upper parts of inner walls at two sides of the drying chamber 4, second drying assemblies 82 respectively located at middle and lower parts of the inner walls at the two sides of the drying chamber 4, and third drying assembly 83 located between the second drying assembly 82 at the middle parts and the second drying assembly 82 at the lower parts. Each of the first drying assembly 81, the second drying assemblies 82 and the third drying assembly 83 includes a plurality of dryers. The dryer includes a microwave power supply for emitting a microwave and radiation port 9. Each radiation port 9 is provided with magnetron 6.

A stacked material is placed on the conveyor 3. The stacked material is a hollow square stack of paper or paper-plastic bags. The conveyor 3 is a normal conveyor, and will not be detailed herein. The conveyor 3 is started to transport the stacked material to conveying device 7 in drying chamber 4. The conveying device 7 can be, but is not limited to a normal conveyor belt or an automatic conveyor roller. The conveying device 7 transports the stacked material into the drying chamber 4. The drying chamber 4 is a circular chamber that facilitates drying around the stacked material. A vacuum environment is formed in the drying chamber 4 through the vacuum pump suction port 41. The drying system 8 is controlled to operate. The drying system 8 includes the second drying assembly 82, the third drying assembly 83, the second drying assembly 82, and the first drying assembly 81 arranged sequentially from bottom to top on the inner wall of the drying chamber 4. The first drying assembly 81 is in a triangular arrangement, while the second drying assembly 82 and the third drying assembly 83 each are in a horizontal arrangement. Each of the first drying assembly 81, the second drying assembly 82 and the third drying assembly 83 includes a plurality of dryers. The dryer includes the microwave power supply for emitting a microwave and the radiation port 9. Each radiation port 9 is provided with the magnetron 6. The first drying assembly 81 dries upper left and upper right sides of the stacked material by the microwave. In the vacuum environment, the boiling point of water molecules decreases, and the microwave energy directly acts on the water molecules, and the water molecules drain out through the gaps between bags in the bag stack. This process does not require heating the bag to high temperature and has high drying efficiency. Meanwhile, microwave drying is performed above a middle part of the stacked material to achieve internal and external drying. The second drying assembly 82 at the lower part dries lower left and lower right sides of the stacked material. The second drying assembly 82 at the middle part dries left and right sides of the stacked material. After the second drying assembly 82 at the middle part completes pre-drying, the system starts the third drying assembly 83 to dry the bags in a middle part of the stack in a concentrated manner. During this process, the microwave energy is fully applied to the bags in the middle, and combined with the microwave energy released to the stacked material by the first drying assembly 81, make the drying uniform in different part of the stack. In this way, the water molecules inside and outside the entire material are subjected to the action of the microwave energy, thereby achieving complete drying. After that, the magnetrons 6 are turned off and the paper stack cool down. The magnetron 6 is an air-cooled magnetron with a simple structure, a long service life, and easy maintenance. In the present disclosure, the first drying assembly 81 and the second drying assemblies 82 dry the upper, middle, and lower parts of the stacked material. The vacuum pump suction port 41 forms a vacuum environment in the drying chamber 4, and the microwave energy released by the drying system 8 directly acts on the water molecules of the paper or paper-plastic bags. The design achieves the drying purpose without heat conduction, without affecting the color and composition of the paper or paper-plastic bag stack, and has high drying efficiency. The third drying assembly 83 releases the microwave energy in a concentrated manner into the bags in the middle part of the paper or paper-plastic bag stack, causing the water molecules in the paper or paper-plastic bags to be affected by microwave energy, thereby achieving uniform complete drying and improving the drying effect.

In some embodiments, the drying chamber 4 is provided with automatic sensing door 2. The automatic sensing door 2 creates a closed space in the drying chamber 4, and automatically issues a warning by sensing a distance between a human body and the drying chamber to avoid endangering safety of the human body. The automatic sensing door is a prior art and will not be detailed herein.

In some embodiments, the equipment chamber 5 is divided into an upper layer, a middle layer and a lower layer. The upper layer and the middle layer of the equipment chamber are provided with cooling circulation system 51 and vacuum pumps 52. The vacuum pump 52 is connected to the vacuum pump suction port 41. The lower layer of the equipment chamber is provided with drainage system 53. The cooling circulation system 51 and the drainage system 53 are connected to the drying chamber 4. The cooling circulation system 51 is connected to the first drying assembly 81, the second drying assemblies 82 and the third drying assembly 83, respectively. The equipment chamber 5 is provided with a plurality of sets of water pumps and transmission motors to form the cooling circulation system 51 and the drainage system 53, and is also provided with a plurality of sets of vacuum pumps 52. These devices each are provided with an intelligent digital protector that can provide a prompt to avoid device failures caused by overload, phase loss, and overcurrent of a certain motor. The cooling circulating system is provided with an R22 refrigerant, a K1 refrigerant (commonly known as antifreeze), an electrical heat dissipation circulating coolant (a mixture of a refrigerant and purified water), and circulating water for external circulation, etc. These liquids are environmentally friendly, non-toxic, non-flammable, non-explosive, stable in chemical properties, flowable, and anti-scale. These are all prior art, and will not be detailed herein.

In some embodiments, a distance between the dryers in the second drying assembly 82 is greater than a distance between the dryers in the third drying assembly 83. The greater distance between the dryers in the second drying assembly 82 facilitates the overall pre-drying of the stacked material and the formation of the dry environment. The smaller distance between the dryers in the third drying assembly 83 facilitates the concentration of the microwave energy to the bags in the middle part, improving the drying effect and ensuring that the entire paper or paper-plastic bag stack is completely and uniformly dried by the microwave energy.

In some embodiments, the conveying device 7 is provided in the drying chamber 4, and a pallet is provided on the conveying device 7. The conveying device 7 is a conveyor belt. The conveyor belt adopts existing polyphenylene sulfide (PPS) injection-molded parts and polyformaldehyde (POM) threaded rods. A single chain plate has a tensile strength of 1.2 tons. A row of 6 chain plates has a tensile strength of approximately 7 tons. The PPS chain plate is resistant to a temperature of 320° C., and has a softening point of 280° C. Fiberglass is adopted for internal reinforcement, and a flame-retardant material is adopted, avoiding highly toxic and harmful substances produced even after combustion, making it safe for long-term use. The pallet is provided as needed. The paper or paper-plastic bag stack is transported from the conveyor 3 to the pallet, which can avoid friction between the paper or paper-plastic bag stack and the conveying device 7 and prevent the collapse of the paper or paper-plastic bag stack. The pallet moves in conjunction with conveying device 7 to avoid local temperature increase or overheating caused by long-term static drying of the paper or paper-plastic bags on the pallet, thus avoiding safety accidents.

In some embodiments, a top of the drying chamber 4 is provided with silencer 42, which effectively reduces the noise inside the drying chamber 4 and the operation sound of drying machine, reducing noise pollution.

In some embodiments, temperature sensors 43 are provided on the top and the inner walls at the two sides of the drying chamber 4. They are configured to perform temperature measurement from the top and left and right sides of the drying chamber 4, respectively, and to control a power of the microwave emitted by the magnetron 6 based on a measured temperature. Thus, they can achieve uniform heating of the paper or paper-plastic bag stack as a whole, avoiding situations where local temperatures are too high and combustion occurs.

In some embodiments, a weighing system is provided in the frame 1. Before the stacked material is dried, the stacked material is weighed and a required water removal amount for drying is calculated. After the drying is completed, the weighing system in the frame 1 weighs the stacked material again and calculates a water removal amount after drying. The water removal amount after drying is used to calculate and determine whether the drying is qualified.

In some embodiments, the start times and microwave frequencies of the first drying assembly 81, the second drying assemblies 82 and the third drying assembly 83 are adjustable. The start times are adjusted to achieve targeted microwave drying treatment for different zones of the stacked material. The different microwave frequencies and the microwaves emitted from different directions are adjusted to form microwave interference superposition at different positions of the stacked material. The drying effect is improved at the microwave interference superposition position. The microwave emission frequencies of the first drying assembly 81, the second drying assemblies 82 and the third drying assembly 83 are adjusted to change the microwave interference superposition position in different zones of the stacked material. In this way, the drying effect at different positions is strengthened and the drying efficiency is improved.

Specifically, the distance between each pair of dryers in the second drying assembly 82 is different from the distance between each pair of dryers in the third drying assembly 83. The microwave frequencies of the second drying assembly 82 and the third drying assembly 83 are adjusted, such that there can be more changes in the microwave interference superposition position, so as to achieve targeted drying of more zones of the stacked material.

In some embodiments, a microwave vacuum low-temperature drying process using the microwave vacuum low-temperature drying machine includes the following steps.
1. The stacked material, namely the paper or paper-plastic bag stack, is weighed, and transported into the drying machine through the conveyor 3. After the stacked material is weighed, the weight of the stacked material before drying is recorded. Then, the stacked material is put on the conveyor 3, and the conveyor 3 transports the stacked material to the pallet of the conveying device 7 in the drying chamber 4.
2. The drying system in the drying machine is controlled to dry the stacked material. The first drying assembly 81 and the second drying assemblies 82 are controlled to pre-dry the stacked material for 10 minutes. The first drying assembly 81 and the second drying assemblies 82 release the microwave energy to the upper, lower, and middle parts of the stacked material. The water molecules inside and outside the stacked material are evaporated to reduce the content of the water molecules, achieving an overall preheating effect. The entire stacked material is in a hot environment. The third drying assembly 83 is started to dry the middle part of the stacked material for 10 minutes in a concentrated manner. The third drying assembly 83 releases the microwave energy to the gaps between the paper or paper-plastic bags of the stacked material. The water molecules in the gaps between the paper or paper-plastic bags are evaporated, and further dried in the preheated environment without being adsorbed on the paper or paper-plastic bags. This step ensures that the stacked material is completely and uniformly dried inside and outside, enhancing the drying effect.
3. After the drying is completed, the weighing system weighs the stacked material, and calculates a weight difference of the stacked material before and after drying, so as to determine whether the drying is qualified. Specifically, the dried stacked material is controlled to enter the weighing system in the drying chamber (4). The weighing system displays the weight of the stacked material after drying. The weight difference of the stacked material before and after drying is calculated to determine whether the drying is qualified.

In some embodiments, a microwave vacuum low-temperature drying process using the microwave vacuum low-temperature drying machine includes the following steps.
1. The stacked material, namely the paper or paper-plastic bag stack, is weighed, and transported into the drying machine through the conveyor 3. After the stacked material is weighed, the weight of the stacked material before drying is recorded. Then, the stacked material is put on the conveyor 3, and the conveyor 3 transports the stacked material to the pallet of the conveying device 7 in the drying chamber 4.
2. The drying system in the drying machine is controlled to dry the stacked material. The third drying assembly 83 is controlled to pre-dry the middle part of the stacked material for 10 minutes. The microwave energy is released to the gaps between the paper or paper-plastic bags of the stacked material. The water molecules in the gaps between the paper or paper-plastic bags escapes to the outside of the stacked material and are exposed within a drying range of the first drying assembly 81 and the second drying assemblies 82. The first drying assembly 81 and the second drying assemblies 82 are started to release the microwave energy to the upper, lower, and middle parts of the stacked material. In this way, the paper or paper-plastic bags in the upper, lower and middle parts of the stacked material are dried, and the outside of the stacked material is also dried. This step ensures that the stacked material is completely and uniformly dried, enhancing the drying effect.
3. After the drying is completed, the weighing system weighs the stacked material, and calculates a weight difference of the stacked material before and after drying, so as to determine whether the drying is qualified. Specifically, the dried stacked material is controlled to enter the weighing system in the drying chamber (4). The weighing system displays the weight of the stacked material after drying. The weight difference of the stacked material before and after drying is calculated to determine whether the drying is qualified.

This specific embodiment is only an explanation of the present disclosure, but it is not a limitation of the present disclosure. After reading this specification, those skilled in the art can make modifications without creative contribution to the present example as needed, but they are protected by patent law as long as these modifications fall within the scope of the present disclosure.

What is claimed is:

1. A microwave vacuum low-temperature drying machine, comprising a frame and a conveyor, wherein a first side of an interior of the frame is provided with a drying chamber, and a second side of the interior of the frame is provided with an equipment chamber; an inner wall of the drying chamber is provided with a vacuum pump suction port; the vacuum pump suction port is connected to the equipment chamber; the inner wall of the drying chamber is further provided with a drying system; the drying system comprises a first drying assembly located at upper parts of inner walls at two sides of the drying chamber, second drying assemblies respectively located at middle and lower parts of the inner walls at the two sides of the drying chamber, and a third drying assembly located between the second drying assembly at the middle parts and the second drying assembly at the lower parts; each of the first drying assembly, the second drying assemblies and the third drying assembly comprises a plurality of dryers; each of the plurality of dryers comprises a microwave power supply for emitting a microwave and a radiation port; and the radiation port is provided with a magnetron.

2. The microwave vacuum low-temperature drying machine according to claim 1, wherein the drying chamber is provided with an automatic sensing door.

3. The microwave vacuum low-temperature drying machine according to claim 1, wherein the equipment chamber is divided into an upper layer, a middle layer and a lower layer; the upper layer and the middle layer of the equipment chamber are provided with a cooling circulation system and a vacuum pump; the vacuum pump is connected to the vacuum pump suction port; the lower layer of the equipment chamber is provided with a drainage system; the cooling circulation system and the drainage system are connected to the drying chamber; and the cooling circulation system is connected to the first drying assembly, the second drying assemblies and the third drying assembly, respectively.

4. The microwave vacuum low-temperature drying machine according to claim 1, wherein a distance between the dryers in the second drying assembly is greater than a distance between the dryers in the third drying assembly.

5. The microwave vacuum low-temperature drying machine according to claim 1, wherein a conveying device is provided in the drying chamber, and a pallet is provided on the conveying device.

6. The microwave vacuum low-temperature drying machine according to claim 1, wherein a top of the drying chamber is provided with a silencer.

7. The microwave vacuum low-temperature drying machine according to claim 1, wherein temperature sensors are provided on a top and the inner walls at the two sides of the drying chamber.

8. The microwave vacuum low-temperature drying machine according to claim 1, wherein a weighing system is provided in the frame.

9. A microwave vacuum low-temperature drying process, using the microwave vacuum low-temperature drying machine according to claim 1, and comprising the following steps:
step 1: weighing a stacked material; and transporting, by the conveyor, the stacked material into the drying machine;
step 2: controlling the first drying assembly and the second drying assemblies to dry upper, lower and middle parts of the stacked material; and controlling the third drying assembly to dry a middle part of the stacked material in a concentrated manner; and
step 3: weighing, by a weighing system, the stacked material after drying; calculating a weight difference of the stacked material before and after drying; and determining whether the drying is qualified.

10. The microwave vacuum low-temperature drying process according to claim 9, wherein in step 2, start times and microwave frequencies of the first drying assembly, the second drying assemblies and the third drying assembly are adjustable;
the start times are controlled to achieve targeted microwave drying treatment in different directions for the stacked material; and
the microwave frequencies of the first drying assembly, the second drying assemblies and the third drying assembly are adjusted to change a microwave interference superposition position, so as to achieve enhanced drying in different zones of the stacked material.

11. The microwave vacuum low-temperature drying process according to claim 9, wherein in the microwave vacuum low-temperature drying machine, the drying chamber is provided with an automatic sensing door.

12. The microwave vacuum low-temperature drying process according to claim 9, wherein in the microwave vacuum low-temperature drying machine, the equipment chamber is divided into an upper layer, a middle layer and a lower layer; the upper layer and the middle layer of the equipment chamber are provided with a cooling circulation system and a vacuum pump; the vacuum pump is connected to the vacuum pump suction port; the lower layer of the equipment chamber is provided with a drainage system; the cooling circulation system and the drainage system are connected to the drying chamber; and the cooling circulation system is connected to the first drying assembly, the second drying assemblies and the third drying assembly, respectively.

13. The microwave vacuum low-temperature drying process according to claim 9, wherein in the microwave vacuum low-temperature drying machine, a distance between the dryers in the second drying assembly is greater than a distance between the dryers in the third drying assembly.

14. The microwave vacuum low-temperature drying process according to claim 9, wherein in the microwave vacuum low-temperature drying machine, a conveying device is provided in the drying chamber, and a pallet is provided on the conveying device.

15. The microwave vacuum low-temperature drying process according to claim 9, wherein in the microwave vacuum low-temperature drying machine, a top of the drying chamber is provided with a silencer.

16. The microwave vacuum low-temperature drying process according to claim 9, wherein in the microwave vacuum low-temperature drying machine, temperature sensors are provided on a top and the inner walls at the two sides of the drying chamber.

17. The microwave vacuum low-temperature drying process according to claim 9, wherein in the microwave vacuum low-temperature drying machine, the weighing system is provided in the frame.
